(19) United States
(12) Patent Application Publication
(10) Pub. No.: US 2004/0203172 A1
(43) Pub. Date: Oct. 14, 2004

(54) Method and apparatus for a chemical sensor

(75) Inventors: Curtis T. Laush JR., Austin, TX (US); Thomas Chi-Tung Huang, Cedar Park, TX (US); Brett Geoffrey Wilson, Lakeway, TX (US); Reginald William Hunter, Round Rock, TX (US)

Correspondence Address: B. Todd Patterson, Moser Patterson & Sheridan, L.L.P., Suite 1500, 3040 Post Oak Blvd., Houston, TX, 77056, US

(73) Assignee: URS CORPORATION

(21) Appl. No.: 10/413,066

(22) Filed: Apr. 14, 2003

(51) Int. Cl. G01N 21/76

(52) U.S. Cl. 436/172; 422/52

(57) ABSTRACT

A method and apparatus for a gas detection system comprises a sample cell containing at least one aperture and a substrate. The substrate comprises a chemiluminescent material that produces photons upon exposure to a fluorine-containing compound. A photo-detector is positioned to receive at least a portion of the photons, wherein the photo-detector generates an electrical output signal relating to a concentration of the fluorine-containing compound.

### BACKGROUND OF THE INVENTION

1. Field of the Invention

Embodiments of the present invention generally relate to analytical methods and apparatus, and more specifically to a system for use in carrying out measurement of gas samples.

2. Description of the Related Art

Employees that are exposed to or handle chemicals in the work environment are protected by regulations imposed by federal and state government, labor unions and employers. Therefore, employers have the responsibility to monitor employee exposure of various chemicals. Many chemicals are non-hazardous at low concentrations, but do have a hazardous threshold at higher concentrations. One group of chemicals that have gained popularity in the workplace is fluorinated chemicals.

Industries that heavily rely on the use of fluorinated chemicals include semiconductor, oil and gas, chemical process, biological and pharmaceutical. As technology in these various sectors proceeds, the use of fluorinated chemicals expand into new applications. Some of the fluorinated chemicals that have common use include fluorine (F₂), hydrogen fluoride (HF), xenon difluoride (XeF₂), oxygen difluoride (OF₂), sulfur hexafluoride (SF₆), nitrogen trifluoride (NF₃), carbonyl difluoride (COF₂), silicon tetrafluoride (SiF₄) and others. These fluorinated chemicals range from severally toxic to non-toxic at various concentrations in humans.

Consequently, industrial demands have increased to detect fluorinated chemicals. These demands include detection at low limits (e.g., 10 ppbv), as well as the ability to differentiate specific fluorinated chemicals at these limits. Furthermore, the abundance of applications for fluorinated chemicals presents varying demands for detection methods. These applications include monitoring various pipes, rooms, tools and other settings containing chemicals.

While U.S. Pat. No. 6,321,587 discloses one embodiment of a fluorine detector, the patent remains silent to the versatility needed by modern demands. The '587 patent is configured in a manner to limit the detection limit; therefore, the described invention possesses shortcomings to particular fluorine concentrations and compounds. Also, the '587 patent discloses either an in-situ monitoring device or an extractive exhaust stream monitoring device, but remains silent about handheld detectors and monitoring devices.

Therefore, there is a need for an apparatus and a method to detect and/or monitor fluorine-containing compounds in an environment, especially for detecting and/or monitoring specific fluorine-containing compounds at selective concentration ranges. There is also a need for a handheld detector as well as a monitoring device for specific fluorine-containing compounds at selective concentration ranges.

### SUMMARY OF THE INVENTION

In one embodiment, the present invention relates generally to a gaseous detection apparatus, comprising a sample cell containing at least one aperture and a substrate, wherein the substrate comprises a chemiluminescent material that produces photons upon exposure to a fluorine-containing compound and a photo-detector positioned to receive at least a portion of the photons, wherein the photo-detector generates an electrical output signal relating to a concentration of the fluorine-containing compound.

In another embodiment, the present invention relates to a gaseous detection apparatus, comprising a sample cell containing at least one aperture and a substrate, wherein the substrate comprises a chemiluminescent material that produces photons upon exposure to a fluorine-containing compound, the substrate comprises a top substrate surface opposite from a bottom substrate surface, the photons are produced on the top substrate surface, a photo-detector positioned to receive at least a portion of the photons, wherein the photo-detector generates an electrical output signal relating to a concentration of the fluorine-containing compound and the substrate and the photo-detector are aligned and the top substrate surface is closer to the photo-detector than the bottom substrate surface.

In yet another embodiment, the present invention provides a portable, gas monitoring apparatus, comprising a sample cell containing a substrate, wherein the substrate comprises a chemiluminescent material that produces photons upon exposure to a fluorine-containing compound, the sample cell is in gas communication with a flow path, the flow path includes at least one aperture and a photo-detector is positioned to receive at least a portion of the photons, wherein the photo-detector generates an electrical output signal relating to a concentration of the fluorine-containing compound.

In another embodiment, the present invention provides a method for monitoring a gas sample, comprising flowing the gas sample through a sample cell containing a substrate, wherein the substrate comprises a chemiluminescent material, exposing the substrate to a fluorine-containing compound within the gas sample, producing photons upon exposure of the chemiluminescent material to the fluorine-containing compound, measuring the photons with a photo-detector and generating an electrical output signal relating to a concentration of the fluorine-containing compound.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic block diagram of a fluorine sensor system.

FIGS. 2-2A are cross-sectional views of a sample cell.

FIGS. 3-3A are cross-sectional views of another sample cell.

FIG. 4 is a graph depicting an example of raw field calibration data within an expected measurement range for fluorine emissions at a plasma abatement device.

FIG. 5 is a graph characterizing the instrument response based on the data in FIG. 4.

FIG. 6 is a cross-sectional view of an in situ detection cell.

FIG. 7 is a cross-sectional view of another in situ detection cell.

FIGS. 8A-8B are cross-sectional views of handheld detectors.

### DETAILED DESCRIPTION OF THE PREFERRED EMBODIMENT

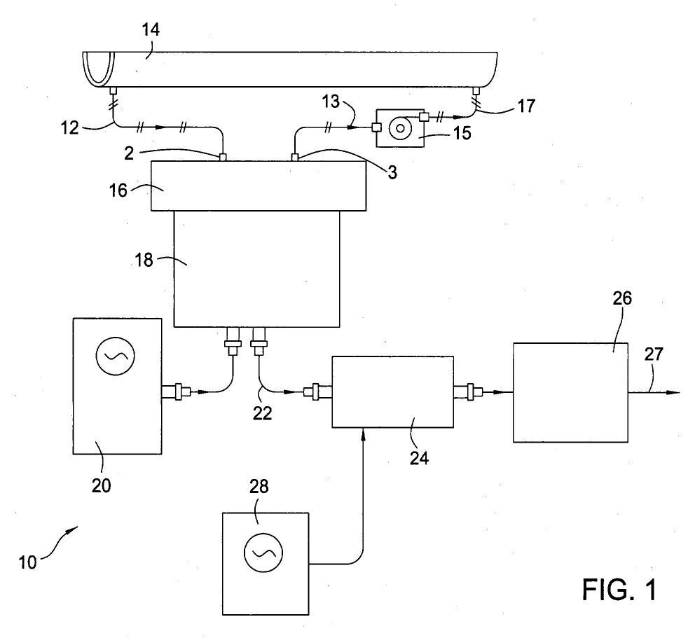

FIG. 1 is a schematic block diagram of a fluorine sensor system 10 that allows for the continuous, real-time detection of fluorine in gaseous streams. System 10 can be applied as either an extractive exhaust stream monitoring device or an in-situ monitoring device. The extracted exhaust stream device has the configuration depicted in FIG. 1 and illustrates how a slipstream 12 may be drawn from an exhaust duct 14 through a sample cell 16 via cell inlet 2 at moderate (less than about 5 slpm) flow rates. The sample gas may have a flow rate in the range from about 2 slpm to about 100 slpm, preferably in the range from about 2 slpm to about 15 slpm. The sample gas can be moved through the sample cell 16 by an optional vacuum pump 15. The vacuum pump 15 can include a diaphragm pump or a venturi pump. The vacuum pump 15 moves gas from the sample cell 16 via an outlet 3 and line 13 and returns the gas to exhaust duct 14 via line 17. When the pump 15 is not included, the sample gas can flow from outlet 3 to the exhaust duct 14 via a solitary line (not shown). In one embodiment, multiple exhaust ducts or multiple extraction points from a single exhaust duct could be monitored with a single sample cell. Feed lines and valves connect each source to the single sample cell to form a system. A purge line is incorporated into the manifold line system and is used to purge the lines between samples.

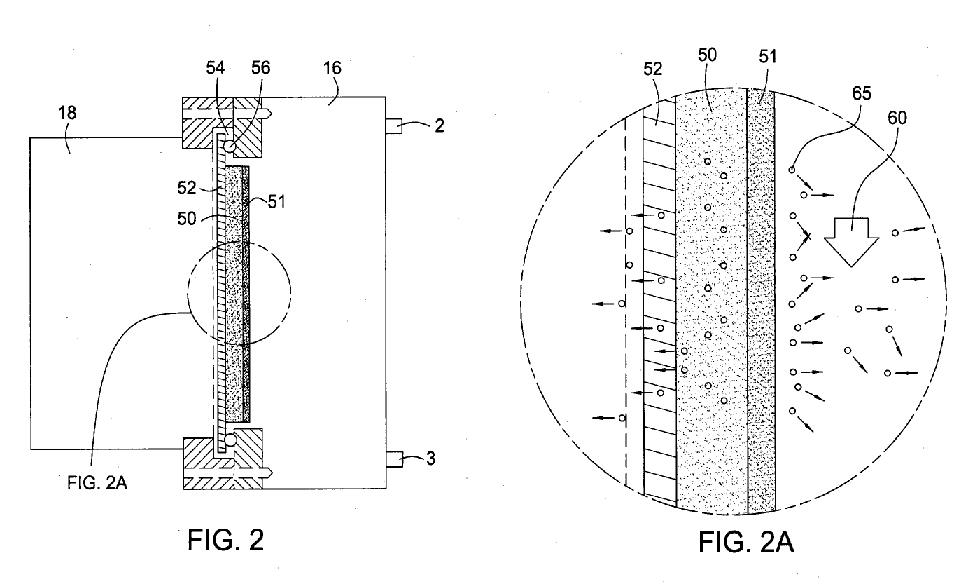

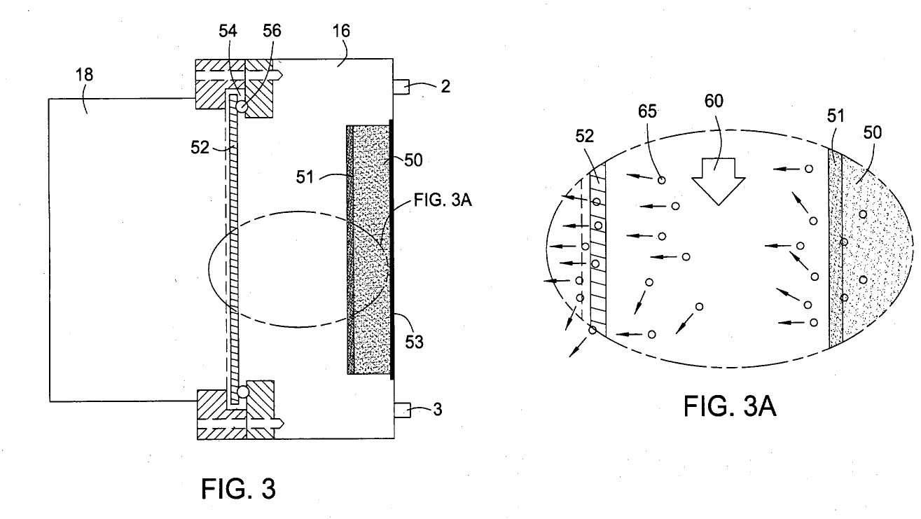

The sample cell 16, further depicted in FIGS. 2-3A, is designed such that the sample gas will uniformly interact with a substrate. In FIGS. 2 and 2A, a substrate 50 is positioned on window 52, while in FIGS. 3 and 3A, a substrate 50 is spaced from but adjacent to window 52. A sample gas 60 flows from inlet 2 and to outlet 3 via the substrate surface 51 in the direction indicated by the arrow.

FIGS. 2 and 2A depict one aspect of a chamber previously disclosed in commonly assigned U.S. Pat. No. 6,321,587, entitled “Solid State Fluorine Sensor System and Method”, that is hereby incorporated by reference in its entirety. The chamber with the substrate on the window, as illustrated in FIG. 2, is herein called the “through-substrate” chamber, since photon detection occurs from photons that have traveled through the substrate. That is, photon detection occurs on the opposite side of the substrate from where the substrate surface is exposed to fluorine-containing gas.

FIGS. 3 and 3A depict another embodiment, herein called the “through-gas” chamber. The through-gas chamber is configured such that photon detection occurs from photons that have not traveled through the substrate, that is, exposure to a fluorine-containing gas and photon detection occur to the same side of the substrate. The through-gas chamber is more sensitive to fluorine-containing compounds than the through-substrate chamber.

The substrate 50 includes at least one chemiluminescent compound that produces light upon exposure to a fluorine-containing compound, such as fluorine. Chemiluminescent compounds that are useful in the apparatus and process include salicylates (e.g., lithium, sodium or potassium) and aluminols. The chemiluminescent compound can be dissolved or suspended to make a solution. The solvent of the solution is aqueous, organic or a combination of aqueous and organic. Specific solvents that are useful in the solution are water, alcohol (e.g., methanol, ethanol, propanol, butanol and higher ordered alcohols), ethers (e.g., diethyl), ketones (e.g., acetone or MEK), tetrahydrofuran, toluene, benzene, xylene, dioxane, alkanes (e.g., pentane, hexane, heptane and higher ordered alkanes) and alkyl-halides (e.g., methyl chloride, methylene chloride or carbon tetrachloride). The solutions can contain dispersion agents, surfactants or other additives.

In one embodiment, such as described in the through-substrate chamber, substrate 50 is made by depositing a chemiluminescent compound on the window 52. In one deposition technique, substrate 50 is made by spraying a saturated, methanol solution of sodium salicylate on the window 52 (e.g., sapphire window). The substrate 50 is allowed to dry as the methanol evaporates to produce a semi-opaque, white residue adhered to a surface of the window 52. The cycle of applying the solution of sodium salicylate and allowing substrate 50 to dry is repeated until a desired film thickness is achieved. A portion of the window making contact with the O-ring may be masked to ensure a good seal.

In one embodiment, the deposition technique involves a saturated solution and ambient temperature. A saturated solution reliably deposits a film at a standard rate. Therefore, a predictable deposition rate provides accurate control during repetitive cycles of film deposition. However, dilute solutions are useful to deposit chemiluminescent compounds with slower deposition rates. For a through-substrate chamber, substrate thickness is one variable that adjusts the sensitivity to the fluorine concentration, since detection occurs on the opposite side of the substrate from where gas exposure occurs. Therefore, controlling the substrate thickness is more important when depositing chemiluminescent compound to be used as a substrate in a through-substrate chamber than in a through-gas chamber.

In another aspect, a chemiluminescent compound and a solvent are combined to make a suspension. The chemiluminescent compound can be deposited upon removal of the solvent within the suspension. The deposition of chemiluminescent compounds via saturated solutions, dilute solutions or suspensions is dependent on the nature of the solubility of the chemiluminescent compound with the solvent. Therefore, the aforementioned means of distributing the chemiluminescent compound in a solvent are each anticipated and considered during the deposition or formation of a substrate.

In another deposition technique, the window 52 can be dipped into a solution or suspension bath, whereas the bath includes the solution as described above. The window is removed and allowed sufficient time to air dry. Several dippings are performed to achieve the desired film thickness. In one aspect, a window is dipped into a saturated, methanol solution of sodium salicylate. The window is removed from the solution and the methanol evaporates to produce a smooth and thin substrate on the window.

Other deposition techniques to deposit the substrate exist, such as a physical vapor deposition (PVD) process. During PVD, a source containing a chemiluminescent compound (e.g., sodium salicylate) is vaporized and deposited to the window. The PVD process is conducted for a period of time long enough to achieve the desired substrate thickness.

In another embodiment, such as described in the through-gas chamber, a chemiluminescent compound is deposited to a support 53 to form the substrate 50. The support 53 is a material that is relatively inert to fluorine and is used to hold the substrate to the inside of the chamber. The support 53 can be transparent or opaque, since photons are not required to diffuse through the support in order to be detected. Materials suitable for use as a support include metals (e.g., stainless steel, anodized aluminum, nickel or platinum), glass or crystal, plastic and combinations thereof. The support 53 can be mounted to the chamber 16 with screws, bolts, rivets, clips, clamps, adhesives and other fasteners known in the art. In one aspect, the support 53 has holes on either end and is fastened to the chamber 16 with screws. In another aspect, the support 53 attaches to the chamber on one side by sliding into a slotted holder.

The chemiluminescent compound is deposited to support 53 by utilizing the techniques discussed for applying the substrate to the window. The support 53 is sprayed with or dipped into the solution or the suspension of the chemiluminescent compound. The solution or suspension is allowed to dry, producing the substrate 50. Applying multiple layers to the support 53 regulates the desired thickness of the substrate. In one aspect, a saturated solution of sodium salicylate in methanol is applied to the support 53. As the methanol evaporates, a thin film of sodium salicylate precipitates and forms a substrate.

In another embodiment, PVD techniques can be applied to deposit the chemiluminescent compound to support 53 to form the substrate 50. In one aspect, a source containing a chemiluminescent compound (e.g., sodium salicylate) is vaporized and deposited to the support. The PVD process is conducted for a period of time long enough to achieve the desired substrate thickness.

In another embodiment, the substrate 50 is made solely of a chemiluminescent compound. A chemiluminescent compound (e.g., potassium salicylate) can be placed into a mold of a hand press. Pressure is applied via the press and the chemiluminescent compound is shaped into a substrate. Holes can be drilled through the edge of the substrate in order to aid in mounting the substrate to the chamber wall.

Photons 65 are created during the reaction of the chemiluminescent compound with fluorine contained in the sample gas 60. Most of the chemiluminescence or fluorescence occurs on the substrate surface 51 of substrate 50. In the embodiment described in FIGS. 2 and 2A, photons 65 must diffuse through substrate 50 and window 52 before being detected by a photo-detector 18. However, in the embodiment described in FIGS. 3 and 3A, photons 65 diffuse through the sample gas 60 and window 52 to the photo-detector 18 and avoid substrate 50. The sensitivity in the later embodiment, utilizing a through-gas chamber, is much higher than in the former embodiment, utilizing a through-substrate chamber, since the substrate 50 absorbs more photons than the sample gas 60. Therefore, in FIGS. 2-2A, the detector's sensitivity to fluorine-containing compounds has a film thickness dependency. This dependency is less noticeable, in the configuration of FIGS. 3-3A, since photons are in a line of sight to the photo-detector and not obscured by the substrate. Suitable photo-detectors include a photo-multiplier tube (PMT), a flat panel PMT, an avalanche photo-detector (APD) and an HDP, available from the Hamamatsu Corporation.

The window 52 is in close proximity (not more than about 15 mm) to a photo-detector 18 with a spectral response in a range from about 300 nm to about 650 nm. The window 52 is made of a material that is hard, transparent to photons or radiation in a range from about 300 nm to about 650 nm and robust to fluorine-containing compounds. Suitable materials for the window 52 include sapphire, magnesium fluoride, calcium fluoride, sodium chloride, magnesium chloride, potassium iodine, crystals or crystalline material, acrylic and other plastics.

Windows and substrates have a variety of dimensions and geometries, including rectangular or circular shapes. In one embodiment, the window has a circular shape with a diameter of about 25 mm and a thickness of about 2 mm. In another embodiment, the window has a rectangular shape with the dimensions of about 25 mm×10 mm and a thickness of about 2 mm. The sample cell 16 can be made of a machined block of aluminum, which is treated (e.g., nickel-plated or anodized) to minimize the interaction with fluorine (or derived gases such as hydrogen fluoride). The sample cell 16 could also be made from stainless steel, nickel, palladium, platinum, plastic, PTFE and other robust materials. The window 52 is seated in a groove 54 with a corrosion-resistant O-ring 56 to provide a leak seal.

In FIG. 1, the photo-detector 18 is provided with power from power supply 20. The photo-detector 18 gain is typically on the order of about 2×10⁶. The photo-detector output 22, with a current approximately in the nanoamp range, can be detected by a commercial picoammeter. Preferably, photo-detector output 22 is amplified by signal converters 24 and 26 and transmitted as output 27, usually in the milliamp range such as required to drive common data acquisition circuits. The signal converters 24 and 26 optionally have the power supply 28.

In one embodiment, optional collection optics are placed between the PMT and the substrate surface. In another embodiment, an APD is substituted for the PMT as the photo-detector. An APD is generally less expensive than a PMT, yet an APD is generally not as sensitive to fluorescence as a PMT. In another embodiment, optional collection optics are placed between the APD and the substrate surface. The larger field of view produced by the collection optics aid an avalanche detector with low sensitivity to view a larger substrate surface than without the collection optics. While examining the larger substrate surface, part of the field of view could be lost without the collection optics. Therefore, in one aspect, a less expensive but very sensitive sensor may include a large substrate, collection optics and an APD.

The chemical reaction between fluorine or fluorine-containing compound and a chemiluminescent compound (e.g., sodium salicylate) causes the substrate to fluoresce in a reproducible and calibrated fashion, as discussed in the following paragraph, so that a mathematical relationship between detector output and fluorine concentration is established.

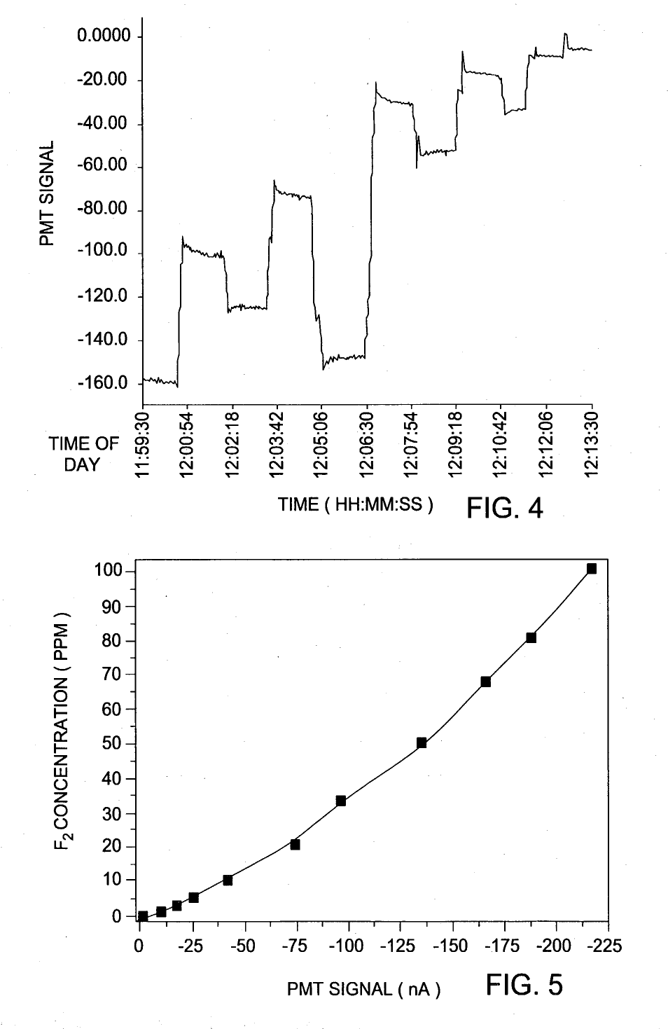

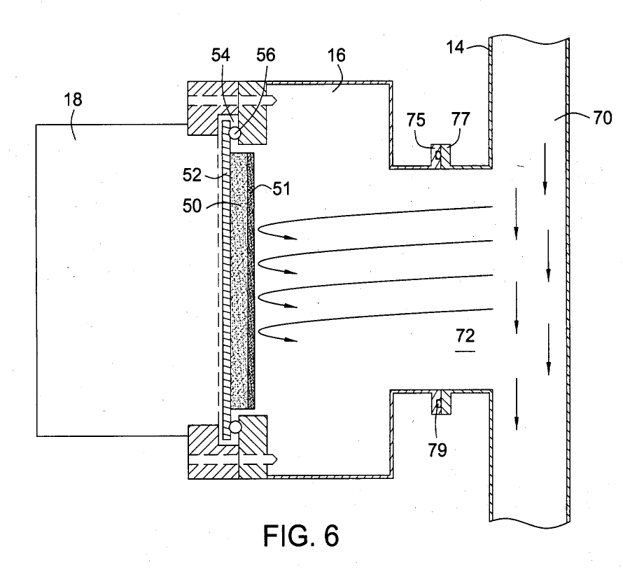

Instrument calibration can be performed in either laboratory or field conditions using certified fluorine gas standards diluted with ultra-high purity gas, (e.g., N₂, Ar or He) under precise flows delivered by mass flow controllers and a dilution manifold. Instrument calibration can also use a fluorine premix or a surrogate gas. FIG. 4 shows an example of raw field-calibration data within an expected measurement range for fluorine emissions at a plasma abatement device. The ordinate represents the photo-detector response in current (expressed as negative nanoamps). The values along the x-axis represent times of day (each collected data point is time stamped). Each level, or data “shelf”, corresponds to the photo-detector output at a given calibration spiking level (fluorine introduced into the sample cell at a known concentration level) while allowing a little time for stabilization. Spiking levels were deliberately staggered to preclude the possibility of “memory effects”, a constant over-estimation of sensor response due to residual fluorine present during sequential step-downs from higher levels. Field calibrations are typically performed in triplicate to verify reproducibility and accuracy before curve fitting. The second order polynomial expressed in FIG. 5 shows the photo-detector current levels (x-axis) plotted against the known fluorine concentration (y-axis) to produce a calibration function that mathematically defines the response of the detector. This characterizes the system response for all low to moderate level real-time fluorine concentration measurements in the range from about 1 ppmv to about 1,000 ppmv. Spiking levels, in the range from about 100 ppmv to about 1,000 ppmv, were performed but not shown in FIG. 5. Calibrations at high fluorine concentrations (about 1,000 ppmv to percentage levels) exhibit a reproducible, but linear behavior.

Statistical analyses of the field calibration data, along with additional high fluorine concentration level runs are performed to define the operating and performance specifications. The sensor provides a sensitive, real-time monitoring device for gaseous fluorine with a robust design. The sensor has been subjected to various ambient air mixtures containing a variety of compounds, including fluorinated or chlorinated compounds (e.g., HF, COF₂, SF₆, HCl, C1₂, O₂, H₂O, silanes, chlorosilanes and SiF₄) to gauge cross interference effects. No detectable responses are observed from the presence of the aforementioned chemicals. Besides fluorine (F₂), the sensor is able to detect other fluorine-containing compounds, such as oxygen difluoride (OF₂), xenon difluoride (XeF₂) and fluorine ions or radicals (e.g., F, F₂ or F₃). The sensor has a detection limit less than about 10,000 ppmv, preferably in the range from about 1 ppbv to about 10,000 ppmv, and most preferably in the range from about 10 ppbv to about 10,000 ppbv. The sensor will also detect fluorine-containing compounds at higher concentrations, such as from about 1% to about 100%.

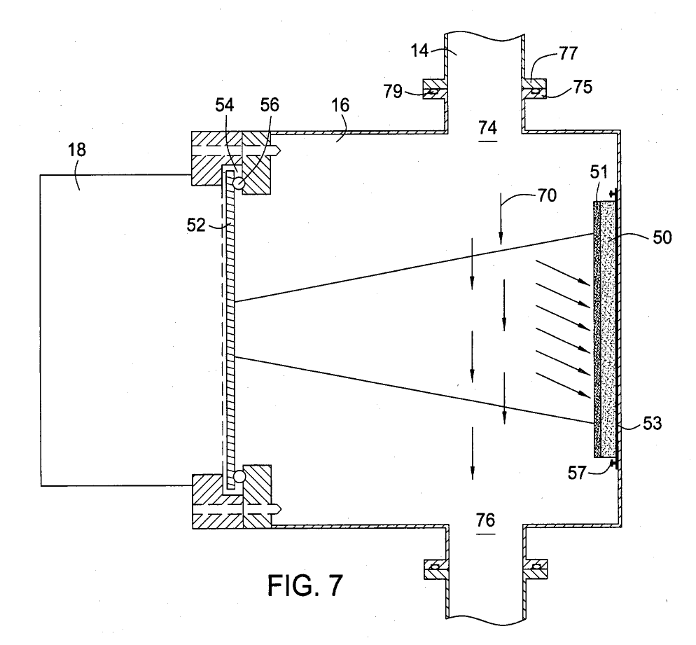

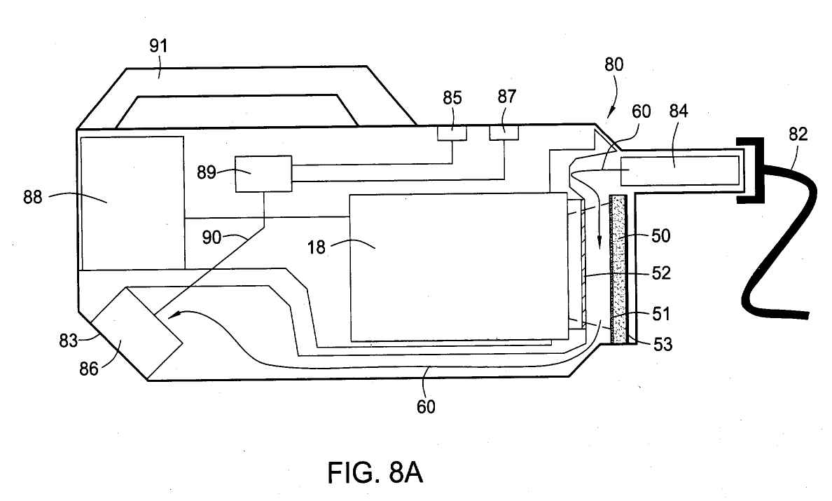

In another embodiment, an in situ monitoring device, as depicted in FIGS. 6 and 7, includes at least one aperture to an exhaust stream. The in situ monitoring device can be positioned along pipes, but can also be placed in storage tanks. The in-situ device has advantages over the extractive exhaust stream device. The in-situ device has a more sensitive detection threshold than the extractive device since more fluorine is exposed to the substrate surface in equivalent fluorine concentrated samples. Also, the in situ device has less gas line connection points (e.g., flanged joints) than the extractive device, therefore the in situ device is less likely to leak the gas stream.

FIG. 6 shows a cross-sectional view of the sample cell 16 as a through-substrate chamber with a single aperture 72. The single aperture 72 is in gas communication with the exhaust stream 70 flowing inside exhaust duct 14. The single aperture 72 can be connected to the exhaust duct 14 by any gas-tight fitting known in the art. One such gas-tight fitting is a flanged joint, demonstrated in FIG. 6 as a T-joint flange. The flanged joint includes flanges 75 and 77 and O-ring 79. The flanged joint is held in place by clamps, bolts, screws, fasteners or other means known in the art (not shown). The exhaust stream 70 passes through aperture 72, crosses the substrate surface 51 and exits the sample cell 17 via aperture 72. As substrate surface 51 is exposed to fluorine-containing compound in the exhaust stream 70, fluorescence from a fluorine-induced reaction is detected by photo-detector 18. However, the sensor is idled while the exhaust stream 70 is absent of fluorine-containing compound.

FIG. 7 shows a cross-sectional view of the sample cell 16 configured as a through-gas chamber. The exhaust stream 70 flows through the sample cell 16 via two apertures, inlet 74 and outlet 76. Inlet 74 and outlet 76 are in gas communication with the exhaust stream 70 flowing inside exhaust duct 14. The apertures can be connected to the exhaust duct 14 by any gas-tight fitting known in the art. One such gas-tight fitting is a flanged joint as demonstrated in FIG. 7, and includes flanges 75 and 77 and O-ring 79. The flanged joint is held in place by clamps, bolts, screws, fasteners or other means known in the art (not shown).

The exhaust stream 70 passes through inlet 74, across the substrate 50 and exits the sample cell 16 via the outlet 76. Substrate 50 includes support 53, which can be attached the chamber with screws 57. As substrate surface 51 is exposed to the exhaust stream 70, fluorescence from a fluorine-induced reaction is detected by photo-detector 18 and fluorine concentration is calculated.

In one aspect (not illustrated), the substrate surface is facing the photo-detector while the substrate is between the photo-detector and the exhaust stream. The substrate surface is exposed to a portion of the exhaust stream that is diverted from behind the substrate to the substrate through at least one aperture.

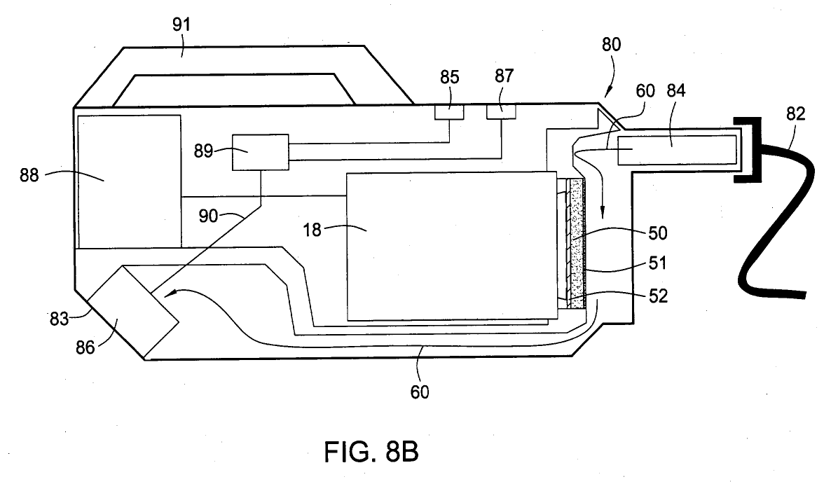

In the embodiment depicted in FIGS. 8A and 8B, a monitoring device is designed to be a handheld leak detector 80. In FIG. 8A, the handheld leak detector 80 contains a substrate 50 attached to a support 53 and positioned on the opposite side of the gas flow from a window 52 and a photo-detector 18. While in FIG. 8B, the handheld leak detector 80 contains a substrate 50 attached to a window 52 and positioned on the same side of the gas flow as a photo-detector 18.

In either aforementioned aspects of a handheld leak detector 80, a sample gas is drawn into inlet 82 along a flow path depicted by the arrow 60, through an optional filter 84 and across substrate 50. The substrate surface 51 is exposed to sample gas and photo-detector 18 detects fluorescence from a fluorine-induced reaction when the sample gas contains fluorine-containing compounds. Processor 89 manages the electrical signals produced by photo-detector 18 and may include a signal amplifier or converter. A data-input device 85 (e.g., controller) and a data-output device 87 (e.g., display, visual alarm or audio alarm) allows user interphase with the leak detector 80. The in-put and out-put devices also contain ports to attach a computer, which can be used to interact with the leak detector 80 (e.g., process data). A fan 86 conveys the remaining sample gas through the leak detector 80 and to the outlet 83 where the sample gas can be dispersed into the ambient air. Circuitry 90 is connected to processor 89, data-input device 85, data-output device 87, fan 86, photo-detector 18 and a power supply 88. The power supply 88 is preferably a battery to provide mobility with the handheld leak detector. In one aspect, the power supply 88 is a rechargeable battery coupled with a built-in charger. The inlet 82 may have a hose and/or nozzle attached thereto and handle 91 provides a means to carry the handheld leak detector.

In another embodiment, the substrate is removable via an opening in the bottom of the chamber (not illustrated). The removable substrate allows easy access to replace a used or improperly functioning substrate. The substrate can be attached directly or via a support to a door closing the opening. In another aspect, the substrate could slide into the chamber and be supported directly or by a support to rails or notch existing in the chamber. A door closes the opening. In another embodiment, substrates functionalized to react and fluoresce with non-fluorine-containing compounds, may be substituted for the chemiluminescent compounds sensitive to fluorine-containing compounds.

The handheld leak detector can be applied as a fluorine sniffer during the examination of pipes containing fluorine gas or other fluorine-containing compounds. A user inspects the air along the vicinity of the pipe. If fluorine has leaked from the pipe and is present, the handheld leak detector will pull the contaminated air into the chamber. The fluorine will react with the chemiluminescent compound and emit photons. The photons are received by the photo-detector and transfers an electrical signal to the processor in turn correlates the amount of photons to fluorine concentration. A real time LCD exhibits the fluorine concentration to the user. During a period when the fluorine concentration is deemed high, i.e., a preset value, alarms (e.g., audio or visual) are initiated. In one aspect, the fan can be configured to automatically turn off to keep from circulating contaminated air.

Industrial uses of fluorine gas often require that an outer pipe encompass an inner pipe containing fluorine. Between the two pipes, a gas flow (e.g., air, nitrogen or argon) provides a cushion in the event of a leak within the inner pipe. An in situ monitoring device or extractive exhaust stream monitoring device is usually placed in communication with a gas flow and identifies a fluorine leak within the inner pipe. The handheld monitor can be utilized to identify fluorine contaminated gas flow from the outer pipe.

In another embodiment of the invention, a fluorine detector is a mountable and stationary device used to give warning of a fluorine leak within the vicinity of the detector, such as in a clean room. The warning can be broadcast in an audio or visual (e.g., light) affair, much like a household smoke detector. The detector can also broadcast selective warnings based on the fluorine concentration. This fluorine detector is programmed to broadcast a warning once a fixed concentration of fluorine-containing compound is achieved within the ambient environment. The preset threshold is preferably low enough to warn workers of a potential hazardous leak, while being high enough as to avoid false alarms from safe traces of fluorine-containing compound that are common in the work environment.

For example, a leak at 10 ppbv is non-hazardous and the detector may flash a yellow light indicating a non-hazardous leak is present. Therefore, the leak can be attended to while workers continue production and there is no evacuation of the work area. However, if a hazardous threshold limit is achieved (e.g., 1 ppmv), then a flashing red light and an audio alarm is engaged alerting the workers to evacuate the work area.

While the foregoing is directed to embodiments of the present invention, other and further embodiments of the invention may be devised without departing from the basic scope thereof, and the scope thereof is determined by the claims that follow.

1. A gaseous detection apparatus, comprising:
a sample cell containing at least one aperture and a substrate, wherein the substrate comprises a chemiluminescent material that produces photons upon exposure to a fluorine-containing compound; and
a photo-detector positioned to receive at least a portion of the photons, wherein the photo-detector generates an electrical output signal relating to a concentration of the fluorine-containing compound.

2. The apparatus of claim 1, wherein the chemiluminescent material is selected from the group consisting sodium salicylate, lithium salicylate, potassium salicylate and aluminol.

3. The apparatus of claim 1, wherein the fluorine-containing compound is selected from the group consisting fluorine, oxygen difluoride and fluorine radicals.

4. The apparatus of claim 1, wherein the photons are transmitted in a spectral range from about 300 nm to about 650 nm.

5. The apparatus of claim 1, wherein the concentration is at a range from about 1 ppbv to about 10,000 ppmv.

6. The apparatus of claim 1, wherein the substrate includes the chemiluminescent material deposited on a support.

7. The apparatus of claim 1, wherein the photo-detector is selected from the group consisting of photo-multiplier tube or avalanche.

8. A gaseous detection apparatus, comprising:
a sample cell containing at least one aperture and a substrate, wherein the substrate comprises a chemiluminescent material that produces photons upon exposure to a fluorine-containing compound;
the substrate comprises a top substrate surface opposite from a bottom substrate surface;
the photons are produced on the top substrate surface;
a photo-detector positioned to receive at least a portion of the photons, wherein the photo-detector generates an electrical output signal relating to a concentration of the fluorine-containing compound; and
the substrate and the photo-detector are aligned and the top substrate surface is closer to the photo-detector than the bottom substrate surface.

9. The apparatus of claim 8, wherein the chemiluminescent material is selected from the group consisting sodium salicylate, lithium salicylate, potassium salicylate and aluminol.

10. The apparatus of claim 8, wherein the fluorine-containing compound is selected from the group consisting fluorine, oxygen difluoride and fluorine radicals.

11. The apparatus of claim 8, wherein the photons are transmitted in a spectral range from about 300 nm to about 650 nm.

12. The apparatus of claim 8, wherein the concentration is at a range from about 1 ppbv to about 10,000 ppmv.

13. The apparatus of claim 8, wherein the substrate includes the chemiluminescent material deposited on a support.

14. The apparatus of claim 8, wherein the photo-detector is selected from the group consisting of photo-multiplier tube or avalanche.

15. A portable, gaseous monitoring apparatus, comprising:
a sample cell containing a substrate, wherein the substrate comprises a chemiluminescent material that produces photons upon exposure to a fluorine-containing compound;
the sample cell is in gas communication with a flow path;
the flow path includes the fluorine-containing compound and at least one aperture; and
a photo-detector positioned to receive at least a portion of the photons, wherein the photo-detector generates an electrical output signal relating to a concentration of the fluorine-containing compound.

16. The apparatus of claim 15, wherein the chemiluminescent material is selected from the group consisting sodium salicylate, lithium salicylate, potassium salicylate and aluminol.

17. The apparatus of claim 15, wherein the fluorine-containing compound is selected from the group consisting fluorine, oxygen difluoride and fluorine radicals.

18. The apparatus of claim 15, wherein the photons are transmitted in a spectral range from about 300 nm to about 650 nm.

19. The apparatus of claim 15, wherein the concentration is at a range from about 1 ppbv to about 10,000 ppmv.

20. The apparatus of claim 15, wherein the substrate includes the chemiluminescent material deposited on a support.

21. The apparatus of claim 15, wherein the at least one aperture is an inlet and an outlet.

22. The apparatus of claim 21, wherein a fan is between the inlet and the outlet.

23. The apparatus of claim 15, wherein the photo-detector is selected from the group consisting of photo-multiplier tube or avalanche.

24. A method for monitoring a gas sample, comprising:
flowing the gas sample through a sample cell containing a substrate, wherein the substrate comprises a chemiluminescent material;
exposing the substrate to a fluorine-containing compound within the gas sample;
producing photons upon exposure of the chemiluminescent material to the fluorine-containing compound;
measuring the photons with a photo-detector; and
generating an electrical output signal relating to a concentration of the fluorine-containing compound.

25. The method of claim 24, wherein flowing the gas sample is at a range from about 2 slpm to about 100 slpm.

26. The method of claim 24, wherein the chemiluminescent material is selected from the group consisting sodium salicylate, lithium salicylate, potassium salicylate and aluminol.

27. The method of claim 24, wherein the fluorine-containing compound is selected from the group consisting fluorine, oxygen difluoride and fluorine radicals.

28. The method of claim 24, wherein measuring the photons is in a spectral range from about 300 nm to about 650 nm.

29. The method of claim 24, wherein the concentration is at a range from about 1 ppbv to about 10,000 ppmv.

30. The method of claim 24, wherein the substrate includes the chemiluminescent material deposited on a support or a window.

31. The method of claim 24, wherein the photo-detector is selected from the group consisting of photo-multiplier tube or avalanche.
